(19) United States
(12) Patent Application Publication
(10) Pub. No.: US 2015/0149515 A1
(43) Pub. Date: May 28, 2015

(54) METHOD AND APPARATUS FOR PROCESSING BROWSING HISTORY OF WEB SITE

(71) Applicant: TENCENT TECHNOLOGY (SHENZHEN) COMPANY LIMITED, Shenzhen (CN)

(72) Inventors: Yang Tong, Shenzhen (CN); Yihong Zhang, Shenzhen (CN)

(21) Appl. No.: 14/605,399

(22) Filed: Jan. 26, 2015

Related U.S. Application Data
(63) Continuation of application No. PCT/CN2013/079426, filed on Jul. 16, 2013.

(30) Foreign Application Priority Data
Aug. 6, 2012 (CN) 201210277041.6

(51) Int. Cl. G06F 17/30; G06F 17/22

(52) U.S. Cl. CPC G06F 17/30312; G06F 17/2247
USPC 707/812

(57) ABSTRACT

The present invention discloses a method for processing a browsing history of a web page, and the method includes: generating a browsing history of a web site; storing an opening time of the web site in the browsing history; generating a key content abstract based on contents of the web site; and storing the key content abstract in the browsing history. An apparatus for processing a browsing history of a web page is also provided.

### FIELD OF THE INVENTION

The present invention relates to web site browsing technologies, more particularly to a method and apparatus for processing a browsing history of a web site.

### BACKGROUND OF THE INVENTION

A browser as an entry of many network services has a significant impact for Internet experiences of a user. Hence manufacturers are actively deploying the browser for each platform.

Generally, the browser provides a function of storing browsing histories, so that the user may trace the network services accessed by the user. However, in the conventional browser, only a network address (e.g. URL of the website) and a title of the web site are stored in the browsing history. In the history page of the browser, the network addresses and titles are listed according to a time order. If the user wants to know details of the web site, the user needs to store an offline backup when browsing the web site or the user needs to load the web site again.

### SUMMARY OF THE INVENTION

Embodiments of the present invention provide a method and apparatus for processing a browsing history of a web site, so as to process the browsing history of the web site more conveniently and directly.

A method for processing a browsing history of a web site includes:

generating a browsing history of a web site;

storing an opening time of the web site in the browsing history;

generating a key content abstract based on contents of the web site; and

storing the key content abstract in the browsing history.

An apparatus for processing a browsing history of a web site includes: a processor for executing instructions stored in a memory, the instructions comprise:

a history generating instruction, to generate a browsing history of a web site;

an opening time storing instruction, to store an opening time of the web site in the browsing history;

a key content abstract generating instruction, to generate a key content abstract based on contents of the web site; and

a key content abstract storing instruction, to store the key content abstract in the browsing history.

In the method and apparatus for processing the browsing history of the web site, besides the opening time, the key content abstract is generated and stored according to the contents of the web site. When the user needs to review the browsing history, the key content abstract of the web site is displayed directly, and it is unnecessary to load the web site again, so that the processing is more convenient and direct.

### BRIEF DESCRIPTION OF THE DRAWINGS

FIG. 1 is a flowchart illustrating a method for processing a browsing history of a web site according to an example of the present invention.

FIG. 2 is a flowchart illustrating a method for processing a browsing history of a web site according to another example of the present invention.

FIG. 3 is a flowchart illustrating a method for processing a browsing history of a web site according to another example of the present invention.

FIG. 4 is a flowchart illustrating a method for processing a browsing history of a web site according to another example of the present invention.

FIG. 5 is a schematic diagram illustrating a time line displayed according to a method for processing a browsing history of a web site according to an example of the present invention.

FIG. 6 is a schematic diagram illustrating a structure of an apparatus for processing a browsing history of a web site according to an example of the present invention.

FIG. 7 is a schematic diagram illustrating a structure of an apparatus for processing a browsing history of a web site according to another example of the present invention.

FIG. 8 is a schematic diagram illustrating a structure of an apparatus for processing a browsing history of a web site according to another example of the present invention.

FIG. 9 is a schematic diagram illustrating a structure of an apparatus for processing a browsing history of a web site according to another example of the present invention.

### DETAILED DESCRIPTION OF THE INVENTION

In order to make the technical solution and merits of the present invention clearer, the present invention will be illustrated in detail hereinafter with reference to the accompanying drawings and specific examples.

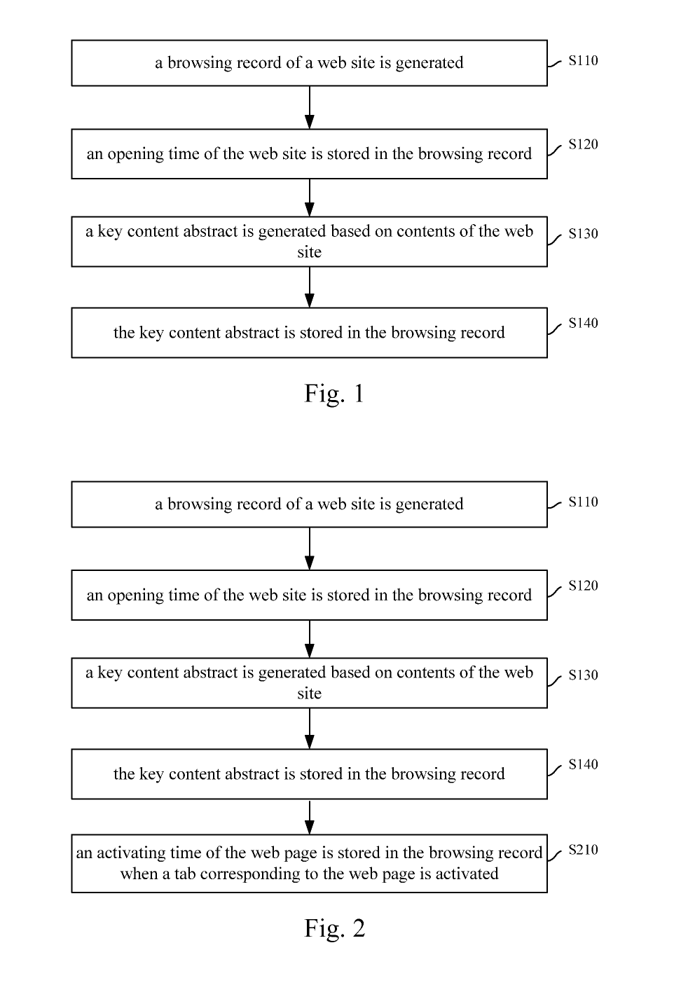

FIG. 1 is a flowchart illustrating a method for processing a browsing history of a web site according to an example of the present invention. As shown in FIG. 1, the method includes the following blocks.

In block S110, a browsing history of a web site is generated.

For example, after a user clicks on a link or directly enters a network address (e.g. a URL) in an address bar via a browser, the browser starts to load a web page and generates a browsing history of the web site to store information of the web site. In examples of the present invention, the browsing history includes data related to the web site, and modes for storing the browsing history are not limited, e.g. the browsing history may be a character string or an object.

In block S120, an opening time of the web site is stored in the browsing history.

The opening time may be a time when the user clicks on the link or when the user presses an enter key after directly entering the network address in the address bar.

In block S130, a key content abstract is generated based on contents of the web site.

In block S140, the key content abstract is stored in the browsing history.

Different web sites have different key contents. For example, the key contents of a news page are text of the news or newsreel; the key contents of a picture page are pictures; the key contents of an audio or video page are contents of the audio or video. Descriptive text about the picture or the audio or video also belongs to the key contents.

Specifically, in block S130, the key contents of the web site are identified, and at least some of characters or at least some of multimedia contents related to the key contents are extracted from the web site. When identifying the key contents, the following processing may be performed: obtaining a Document Object Model (DOM) of the web site after the web site is loaded; traversing the DOM; extracting labels of multimedia contents included in the contents of the web site; and determining whether the label belongs to the key contents according to attributes of the label. The labels of the multimedia contents include <object>, <embed>, <img> and etc. The modes for identifying the key contents and determining whether the label belongs to the key contents according to attributes of the label may refer to conventional web intelligent recognition technologies.

According to an example, when the key contents are multimedia contents, the multimedia contents may be taken as the key content abstract as a whole. The multimedia contents needs larger storage space, according to an example, compression or clipping processing may be performed for the multimedia contents. For example, a picture may be compressed or cut; clipping processing may be performed for an audio or video file.

When there is no multimedia content, the web site is determined as a text-based web site, all of or parts of the contents of the web site may be taken as the key content abstract.

After the key content abstract is obtained, the key content abstract is stored in the browsing history. In the examples of the present invention, when the key content abstract is stored in the browsing history, the key content abstract is associated with the browsing history, and the key content abstract and the browsing history may be not stored in the same physical storage area. For example, the multimedia contents and the browsing history may be stored in different storage areas and an index of the multimedia contents may be stored in the browsing history.

In addition, besides the opening time and the key content abstract, other information may be stored in the browsing history. According to an example, the browsing history has the following structure: Struct {string title, string link, string show_txt, bool bflag, string html_media, Time Opentime, Time CloseTime}. Herein, title indicates the title of the web site, link indicates the web address, show_txt indicates the characters in the key content abstract, bflag indicates whether multimedia contents are included, html_media indicates the multimedia contents, OpenTime indicates the opening time, CloseTime indicates a closing time.

According to an example, after block S104 is performed, if the browsing history is stored in a transitory storage medium, the browsing history may be further stored in a non-transitory storage medium, e.g. a flash or a hard disk, so that the browsing history may be used repeatedly. In an example, the browsing history is stored into a file or a database system.

In the method for processing the browsing history of the web site, besides the opening time, the key content abstract is generated and stored according to the contents of the web site. When the user needs to review the browsing history, the key content abstract of the web site is displayed directly, and it is unnecessary to load the web site again, so that the processing is more convenient and direct.

FIG. 2 is a flowchart illustrating a method for processing a browsing history of a web site according to another example of the present invention. As shown in FIG. 2, besides the processing shown in FIG. 1, the following processing is included in this example.

In block S210, an activating time of the web page is stored in the browsing history when a tab corresponding to the web page is activated.

Generally, multiple tabs are displayed at the same time in one browser, and each tab corresponds to one network address. In the browser, only one tab is activated simultaneity. By monitoring an activating event of the tab, the activating time of the web page may be recorded.

It should be understood that, when the history is traced, the activating time of the tab may be regarded as the time of opening the web page again. Hence, according to the method for processing the browsing history of the web page provided by examples of the present invention, when the history is displayed, the entire browsing process is displayed.

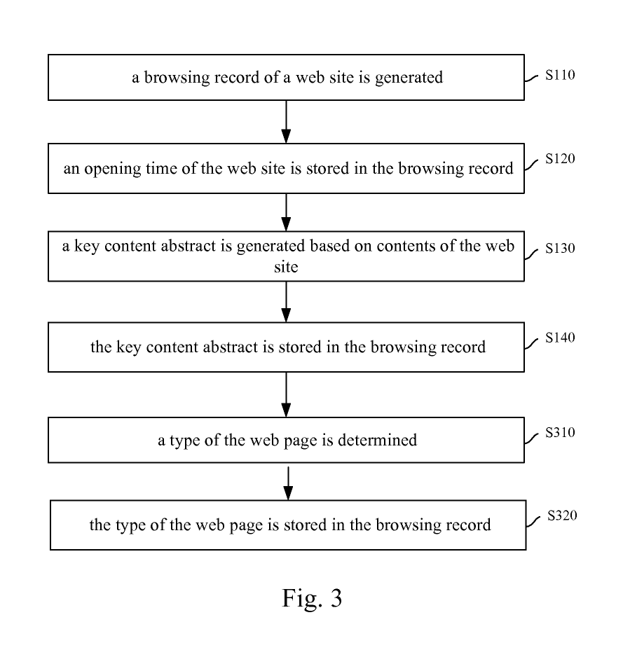

FIG. 3 is a flowchart illustrating a method for processing a browsing history of a web site according to another example of the present invention. As shown in FIG. 3, besides the processing shown in FIG. 1, the following processing is included in this example.

In block S310, a type of the web page is determined.

In block S320, the type of the web page is stored in the browsing history.

According to an example, the type of the web page is determined according to attributes of the web page, the type of the web page may be news, technology, entertainment, sports, star and etc.

According to an example, the type of the web page may be determined according to the network address of the web page. Network address rules may be preconfigured, and the type of the web page is determined according to the rules. When no rule is matched, the type of the web page is determined artificially, or the type of the web page is determined by using a web page classifier based on natural language recognition.

Hence, according to the method for processing the browsing history of the web page provided by examples of the present invention, the type of the web page is determined, so that when the user tracks the history, the web pages may be filed, and it is convenient for the user to trace the web pages of a certain type.

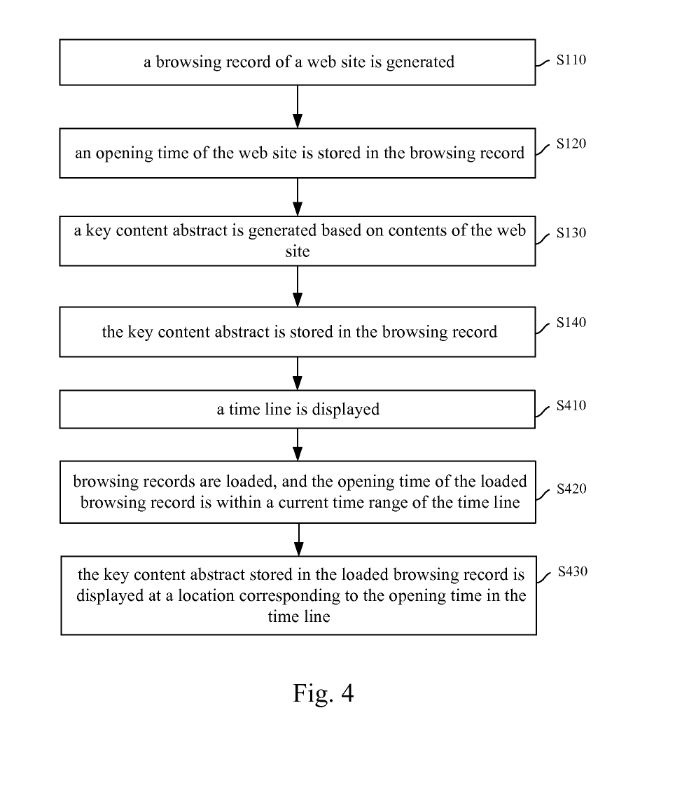

FIG. 4 is a flowchart illustrating a method for processing a browsing history of a web site according to another example of the present invention. As shown in FIG. 4, besides the processing shown in FIG. 1, the following processing is included in this example.

In block S410, a time line is displayed.

In block S420, browsing histories are loaded, and the opening time of the loaded browsing history is within a current time range of the time line.

In block S430, the key content abstract stored in the loaded browsing history is displayed at a location corresponding to the opening time in the time line.

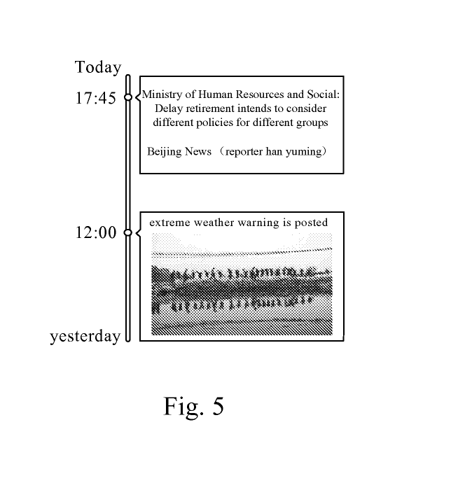

As shown in FIG. 5, two endpoints of the time line represent a start time and an end time respectively. The time period between the start time and the end time is the current time range. The current time range may be adjusted by the user, so that the user may check the earlier browsing histories.

After the current time range is determined, the browsing histories having the opening time within the current time range is loaded, and the key content abstracts in the loaded browsing histories are formatted according to a preset format. For example, the key content abstract may be transformed as HTML codes which can be displayed by the browser. After the formatting operation, as shown in FIG. 5, each of the formatted key content abstracts is displayed at the location corresponding to the opening time in the time line. As described in the above example, the opening time may be the time when the web page is opened firstly and the activating procedure of the tab is omitted, or the opening time may include the activating time of the tab, so that the completely browsing history is shown in the time line.

In the example shown in FIG. 5, the timeline is vertical, in another example, the timeline may be horizontal.

In addition, in block S420, the types of the web pages in the browsing histories may be filtered. For example, only the web pages of news and video may be loaded. The types of the web pages to be loaded may be designated by the user. For example, a link or a button of the type may be displayed, after the user clicks on the link or the button, the browsing history corresponding to the link or the button is displayed.

Further, in block S420, besides the browsing histories having the opening time within the current time range are loaded, the browsing histories having the activating time within the current time range are loaded.

Further, the current time range of the time line may be adjusted automatically and dynamically based on a certain speed, so that the browsing histories are switched automatically.

According to the method for processing the browsing history of the web page provided by examples of the present invention, the browsing histories are organized via the time line, so that the user may view the browsing histories conveniently and directly. In addition, it is unnecessary to load the key contents of the web page again, and the browsing histories are viewed more smoothly.

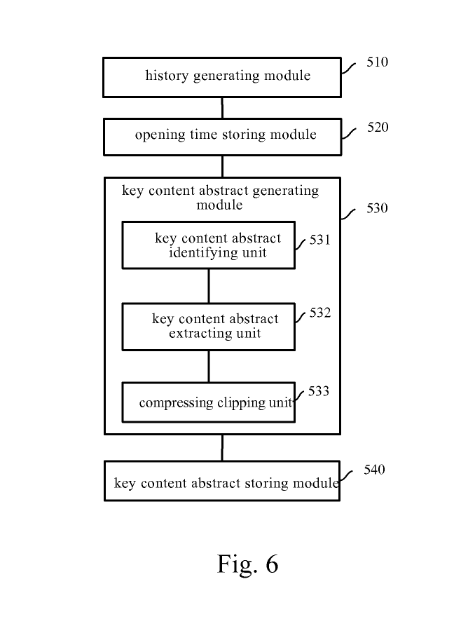

FIG. 6 is a schematic diagram illustrating a structure of an apparatus for processing a browsing history of a web site according to an example of the present invention. As shown in FIG. 6, the apparatus 500 includes a history generating module 510, an opening time storing module 520, a key content abstract generating module 530, and a key content abstract storing module 540.

The history generating module 510 is to generate a browsing history of a web site. For example, after a user clicks on a link or directly enters a network address in an address bar via a browser, the browser starts to load a web page and generates a browsing history of the web site to store information of the web site. In examples of the present invention, the browsing history includes data related to the web site, and modes for storing the browsing history are not limited, e.g. the browsing history may be a character string or an object.

The opening time storing module 520 is to store an opening time of the web site in the browsing history. The opening time may be a time when the user clicks on the link or when the user presses an enter key after directly entering the network address in the address bar.

The key content abstract generating module 530 is to generate a key content abstract based on contents of the web site.

Different web sites have different key contents. For example, the key contents of a news page are text of the news or newsreel; the key contents of a picture page are pictures; the key contents of an audio or video page are contents of the audio or video. Descriptive text about the picture or the audio or video also belongs to the key contents. According to an example, the key content abstract generating module 530 includes: a key content abstract identifying unit 531 and a key content abstract extracting unit 532.

The key content abstract identifying unit 531 is to identify the key contents of the web site, and the key content abstract extracting unit 532 is to extract at least some of characters or at least some of multimedia contents related to the key contents from the web site.

Specifically, when identifying the key contents, the following processing may be performed: obtaining a Document Object Model (DOM) of the web site after the web site is loaded; traversing the DOM; extracting labels of multimedia contents included in the contents of the web site; and determining whether the label belongs to the key contents according to attributes of the label. The labels of the multimedia contents include <object>, <embed>, <img> and etc. The modes for identifying the key contents and determining whether the label belongs to the key contents according to attributes of the label may refer to conventional Web Intelligent Recognition Technologies.

According to an example, when the key contents are multimedia contents, the multimedia contents may be taken as the key content abstract as a whole. The multimedia contents needs larger storage space, according to an example, compression or clipping processing may be performed for the multimedia contents. For example, a picture may be compressed or cut; clipping processing may be performed for an audio or video file. That is, the key content abstract generating module 530 may further comprise a compressing clipping unit 533 to perform the above processing.

When there is no multimedia content, the web site is determined as a text-based web site, all of or parts of the contents of the web site may be taken as the key content abstract.

The key content abstract storing module 540 is to store the key content abstract in the browsing history after the key content abstract is obtained.

According to an example, when the key content abstract is stored in the browsing history, the key content abstract is associated with the browsing history, and the key content abstract and the browsing history may be not stored in the same physical storage area. For example, the multimedia contents and the browsing history may be stored in different storage areas and an index of the multimedia contents may be stored in the browsing history.

In the apparatus for processing the browsing history of the web site, besides the opening time, the key content abstract is generated and stored according to the contents of the web site. When the user needs to review the browsing history, the key content abstract of the web site is displayed directly, and it is unnecessary to load the web site again, so that the processing is more convenient and direct.

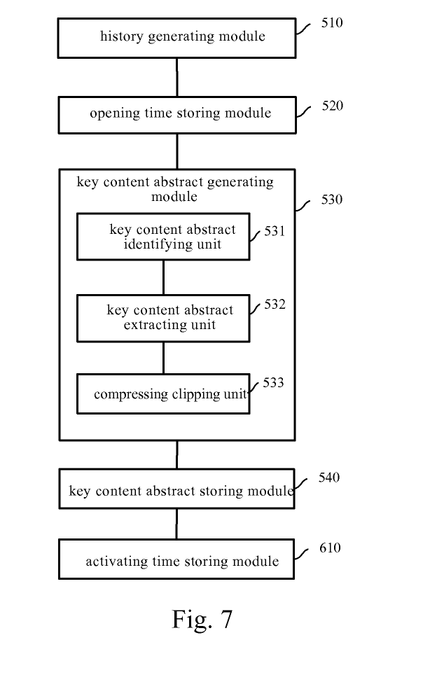

FIG. 7 is a schematic diagram illustrating a structure of an apparatus for processing a browsing history of a web site according to another example of the present invention. As shown in FIG. 7, besides the modules shown in FIG. 6, an activating time storing module 610 is included. The activating time storing module 610 is to store an activating time of the web page in the browsing history when a tab corresponding to the web page is activated.

Generally, multiple tabs are displayed at the same time in one browser, and each tab corresponds to one network address. In the browser, only one tab is activated simultaneity. By monitoring an activating event of the tab, the activating time of the web page may be recorded.

Hence, according to the apparatus for processing the browsing history of the web page provided by examples of the present invention, the activating time of the tab is stored, so that when the history is displayed, the entire browsing process is displayed.

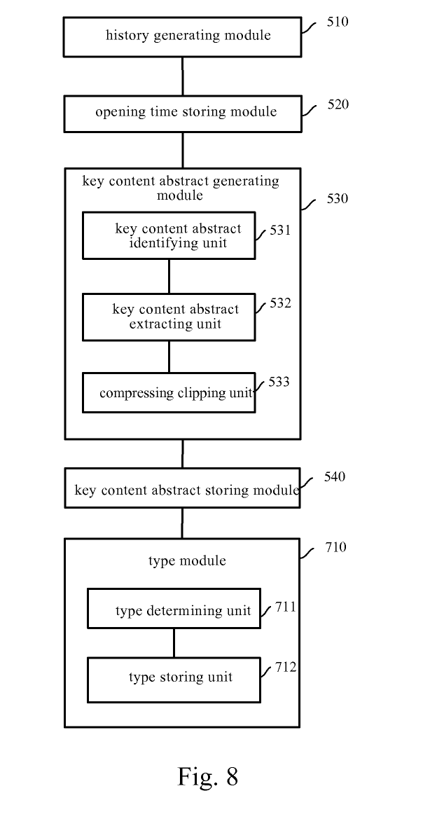

FIG. 8 is a schematic diagram illustrating a structure of an apparatus for processing a browsing history of a web site according to another example of the present invention. As shown in FIG. 7, besides the modules shown in FIG. 6, a type module 710 is included. The type determining module includes a type determining unit 711 and a type storing unit 712.

The type determining unit 711 is to determine a type of the web page.

The type storing unit 712 is to store the type of the web page in the browsing history.

According to an example, the type of the web page is determined according to attributes of the web page, the type of the web page may be news, technology, entertainment, sports, star and etc.

According to an example, the type of the web page may be determined according to the network address of the web page. Network address rules may be preconfigured, and the type of the web page is determined according to the rules. When no rule is matched, the type of the web page is determined artificially, or the type of the web page is determined by using a web page classifier based on natural language recognition.

Hence, according to the apparatus for processing the browsing history of the web page provided by examples of the present invention, the type of the web page is determined, so that when the user tracks the history, the web pages may be filed, and it is convenient for the user to trace the web pages of a certain type.

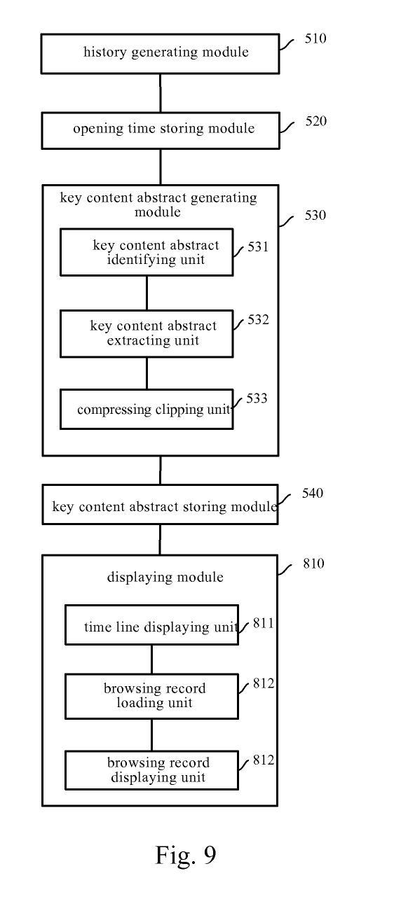

FIG. 9 is a schematic diagram illustrating a structure of an apparatus for processing a browsing history of a web site according to another example of the present invention. As shown in FIG. 7, besides the modules shown in FIG. 6, a displaying module 810 is included.

The displaying module 810 includes a time line displaying unit 811, a browsing history loading unit 812 and a browsing history displaying unit 813.

The time line displaying unit 811 is to display a time line.

The browsing history loading unit 812 is to load browsing histories having the opening time within a current time range of the time line.

The browsing history displaying unit 813 is to display the key content abstract stored in the loaded browsing history at a location corresponding to the opening time in the time line.

As shown in FIG. 5, two endpoints of the time line represent a start time and an end time respectively. The time period between the start time and the end time is the current time range. The current time range may be adjusted by the user, so that the user may check the earlier browsing histories.

After the current time range is determined, the browsing histories having the opening time within the current time range is loaded, and the key content abstracts in the loaded browsing histories are formatted according to a preset format. For example, the key content abstract may be transformed as HTML codes which can be displayed by the browser. After the formatting operation, as shown in FIG. 5, each of the formatted key content abstracts is displayed at the location corresponding to the opening time in the time line.

In the example shown in FIG. 5, the timeline is vertical, in another example, the timeline may be horizontal.

In addition, the browsing history loading unit 812 may be further to filter the types of the web pages in the browsing histories. For example, only the web pages of news and video may be loaded. The types of the web pages to be loaded may be designated by the user. For example, a link or a button of the type may be displayed, after the user clicks on the link or the button, the browsing history corresponding to the link or the button is displayed.

Further, the current time range of the time line may be adjusted automatically and dynamically based on a certain speed, so that the browsing histories are switched automatically. That is, the displaying module 810 further includes a time line adjusting unit to adjust the current time range of the time line based on a certain speed.

Further, besides to load the browsing histories having the opening time within the current time range, the browsing history loading unit 812 is further to load the browsing histories having the activating time within the current time range.

According to the apparatus for processing the browsing history of the web page provided by examples of the present invention, the browsing histories are organized via the time line, so that the user may view the browsing histories conveniently and directly. In addition, it is unnecessary to load the key contents of the web page again, and the browsing histories are viewed more smoothly.

The methods and modules described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to realize a technical scheme of any of the above examples.

The foregoing is only preferred examples of the present invention and is not used to limit the protection scope of the present invention. Any modification, equivalent substitution and improvement without departing from the spirit and principle of the present invention are within the protection scope of the present invention.

1. A method for processing a browsing history of a web page comprising:
generating a browsing history of a web site;
storing an opening time of the web site in the browsing history;
generating a key content abstract based on contents of the web site; and
storing the key content abstract in the browsing history.

2. The method of claim 1, wherein generating a key content abstract based on contents of the web site comprises:
identifying key contents of the web site;
extracting characters or multimedia contents related to the key contents from the web site.

3. The method of claim 2, further comprising:
If the multimedia contents are extracted, performing at least one of compressing and clipping processing for the multimedia contents.

4. The method of claim 1, further comprising:
determining a type of the web page;
storing the type of the web page in the browsing history.

5. The method of claim 1, further comprising:
displaying a time line;
loading a browsing history having an opening time within a current time range of the time line;
displaying a key content abstract stored in the loaded browsing history in the time line at a location corresponding to the opening time.

6. The method of claim 5, further comprising:
filtering the type of the web page when loading the browsing history having the opening time within the current time range of the time line.

7. An apparatus for processing a browsing history of a web page comprising: a processor for executing instructions stored in a memory, the instructions comprise:
a history generating instruction, to generate a browsing history of a web site;
an opening time storing instruction, to store an opening time of the web site in the browsing history;
a key content abstract generating instruction, to generate a key content abstract based on contents of the web site; and
a key content abstract storing instruction, to store the key content abstract in the browsing history.

8. The apparatus of claim 7, wherein the key content abstract generating instruction comprises:
a key content abstract identifying sub-instruction, to identify key contents of the web site, and
a key content abstract extracting sub-instruction, to extract characters or multimedia contents related to the key contents from the web site.

9. The apparatus of claim 8, wherein the key content abstract generating instruction comprises:
a compressing clipping sub-instruction, to perform at least one of compressing and clipping processing for multimedia contents.

10. The apparatus of claim 7, further comprising a type instruction, wherein the type instruction comprises:
a type determining sub-instruction, to determine a type of the web page; and
a type storing sub-instruction, to store the type of the web page in the browsing history.

11. The apparatus of claim 7, further comprising
a time line displaying sub-instruction, to display a time line;
a browsing history loading sub-instruction, to load a browsing history having an opening time within a current time range of the time line; and
a browsing history displaying sub-instruction, to display a key content abstract stored in the loaded browsing history in the time line at a location corresponding to the opening time.

12. The apparatus of claim 11, wherein the browsing history loading sub-instruction is further to filter the type of the web page when loading the browsing history having the opening time within the current time range of the time line.
